(19) United States
(12) Patent Application Publication
(10) Pub. No.: US 2025/0083302 A1
(43) Pub. Date: Mar. 13, 2025

(54) ROBOTS WITH LIFT MECHANISMS

(71) Applicant: Kabushiki Kaisha Toshiba, Tokyo (JP)

(72) Inventor: Marius JURT, Bristol (GB)

(73) Assignee: Kabushiki Kaisha Toshiba, Tokyo (JP)

(21) Appl. No.: 18/294,064

(22) PCT Filed: Apr. 28, 2023
(86) PCT No.: PCT/IB2023/054458

§ 371 Date: Jan. 31, 2024

Related U.S. Application Data
(63) Continuation of application No. 17/733,149, filed on Apr. 29, 2022, now abandoned.

(51) Int. Cl. B25J 9/00; B25J 5/00; B25J 9/16; B25J 13/08

(52) U.S. Cl. CPC B25J 9/0009; B25J 5/007; B25J 9/1669; B25J 13/088

(57) ABSTRACT

A robot (100) comprising a drive (120) for moving the robot (100) and a lift means (130) for elevating the robot (100) above a surface such that another identical robot (150) is able to move underneath the elevated robot (100).

### FIELD OF THE INVENTION

The present invention relates to a robots configured to elevate themselves above surfaces that they travel on, to systems comprising such robots, and to methods performed by such robots.

### BACKGROUND

Robotic systems may be used in warehouses and other storage facilities to automate retrieval and handling of objects in highly structured environments. However, such systems can be expensive customised solutions to specific facilities that use multiple different robots to perform different handling tasks. Such systems are not suitable for storage spaces that require more adaptability and flexibility or that need to serve different purposes at different times, for example, with changing layouts.

An object of embodiments described herein is to provide improved robotic systems for facilitating object storage and handling in a variety of locations.

Arrangements of the embodiments will be understood and appreciated from the following detailed description, made by way of example and taken in conjunction with the drawings.

### BRIEF DESCRIPTION OF THE FIGURES

FIG. 1a shows an embodiment of a robot in an un-elevated configuration with its legs withdrawn;

FIG. 1b shows the robot of FIG. 1a in an un-elevated configuration with its legs deployed out of its body;

FIG. 1c shows the robot of FIG. 1a in an elevated configuration with its legs deployed out of its body and extended;

FIG. 1d shows the robot of FIG. 1a in the elevated configuration with its legs displaced out of its movement footprint and extended, and another identical robot with its legs withdrawn to within its movement footprint arranged beneath it;

FIG. 1e shows the robot of FIG. 1a with its legs displaced out of its movement footprint stacked on another identical robot with its legs displaced out of its movement footprint;

FIG. 1f shows the robot of FIG. 1a with its legs withdrawn stacked on another identical robot arranged with its legs withdrawn;

FIG. 2a is a base-view of the robot of FIG. 1a showing movement of its wheels and legs;

FIG. 2b is a base-view of the robot of FIG. 1a with its wheels oriented to move in a first direction;

FIG. 2c is a base-view of the robot of FIG. 1a with its wheels oriented to move in a second perpendicular direction;

FIG. 2d is a base-view of the robot of FIG. 1 in an elevated configuration such that other robots can move beneath it in the first and second directions;

FIG. 3a shows an embodiment of a robot in an un-elevated configuration with its legs withdrawn;

FIG. 3b shows the robot of FIG. 3a in an un-elevated configuration with its legs deployed to lateral positions;

FIG. 3c shows an embodiment of a robot in an un-elevated configuration with its legs withdrawn;

FIG. 3d shows the robot of FIG. 3c in an un-elevated configuration with its legs deployed to offset lateral positions;

FIG. 4a shows a top-down view of an arrangement of a plurality of robots as shown in FIGS. 1a to 1f;

FIG. 4b shows a top-down view of an arrangement of a plurality of robots as shown in FIGS. 3a and 3b;

FIG. 4c shows a top-down view of an arrangement of a plurality of robots as shown in FIGS. 3c and 3d;

FIG. 5 shows a plurality of robots packed together in a first configuration;

FIG. 6 shows an upper surface of an embodiment of a robot comprising extended bridging supports and tracks or rails;

FIG. 7a shows a plurality of robots packed together in a second configuration;

FIG. 7b shows a plurality of robots packed together in a third configuration;

FIG. 8 shows stages of an embodiment of a stacking method performed by a pair of robots;

FIG. 9 shows stages of an embodiment of a tunnelling method performed by a plurality of robots;

FIG. 10 shows an embodiment of a robot comprising a structural frame;

FIG. 11 is a diagram of a logistics network utilising a plurality of robots;

FIG. 12 is a diagram of a facility utilising a plurality of robots;

FIG. 13 is a flowchart of a method of operating a robot;

FIG. 14a is a top-down view of an embodiment of a robot with its legs withdrawn FIG. 14b is a top-down view of the robot of FIG. 14a with its legs deployed.

### DETAILED DESCRIPTION

According to an embodiment, there is provided a robot comprising a drive for moving the robot over a surface and a lift mechanism for elevating the robot above the surface such that another identical robot is able to move underneath the elevated robot.

The lift mechanism may comprise a plurality of legs configured to be laterally displaced into and out of a footprint of the remainder of the robot and to extend lengthwise.

The legs may only extend lengthwise when laterally displaced out of the footprint of the remainder of the robot.

The robot may comprise a single actuator for extending all of the plurality of legs or multiple synchronized actuators for extending the legs, such as an individual actuator for extending each leg.

The plurality of legs may be configured to be displaced into and out of opposite lateral faces of a body of the robot in a direction perpendicular to these faces.

The plurality of legs may be configured to be displaced out of the footprint of the remainder of the robot to positions on an extension of a diagonal of the robot's footprint and offset from corners of the footprint of the remainder of the robot, such that they do not obstruct any face of the body along an axis perpendicular to that face.

The plurality of legs may be configured to be displaced into and out of vertical edges or faces of a body of the robot at corners of the footprint of the remainder of the robot, such that they do not obstruct any face of the body along an axis perpendicular to that face.

The plurality of legs may be configured to be laterally displaced into and out of a pair of opposite faces of a body of the robot.

The plurality of legs may be configured to be laterally displaced out of the footprint of the remainder of the robot to positions adjacent a pair of opposite faces of the robot, which may be faces out of which they were displaced.

The legs may each configured to be laterally displaced into and out of the opposite faces of the body in a direction perpendicular the opposite faces.

Positions to which the legs are laterally displaced out of the pair of opposite faces of the robot may each be at an edge of the opposite faces that defines a corner of the body of the robot.

Alternatively, two of legs may be displaced to positions at edges of the opposite faces that define opposite corners of the body of the robot, and two of the legs may be displaced to positions part-way along said opposite faces that are separated from two other corners of the body by at least a width of one of the plurality of legs.

In some embodiments, the plurality of legs are configured to be displaced into and out of the footprint of the robot linearly.

In some embodiments, the plurality of legs are configured to be displaced into and out of the footprint by rotating the legs about a respective axis parallel to their lengths. The axes about which the legs are rotated may coincide or substantially coincide with an outer vertical edge of the robot and/or a corner of the body or footprint of the robot.

The one or more legs may be flush with, and/or may define parts of, lateral faces of the body of the robot when they are displaced into the body of the robot.

One or more of the legs may comprise an electrical connector or inductive charger at its lower end, through which a rechargeable electrical battery comprised by the robot may be charged.

One or more of the legs may comprise an electrical connector or inductive charger at its upper end, through which it may charge another robot stacked on top of the robot.

Alternatively, or additionally, the robot may comprise an electrical connector or inductive charger in a base of its body, through which a rechargeable electrical battery comprised by the robot may be charged, and may comprise an electrical connector or inductive charger in an upper surface of its body, through which it may charge another robot stacked on top of the robot.

The robot may comprise one or more connectors for connecting an end of at least one of the legs to an opposite end of a leg of another identical robot and/or for connecting to connection points on the surface.

The connector(s) may comprise one or more connectors at an upper end of a leg for connecting the upper end of the leg to a lower end of a leg of another identical robot above the robot, and/or one or more connectors at a lower end of a leg for connecting the lower end of the leg to an upper end of a leg of another identical robot below the robot.

The robot may comprise a connector at an end of each of the plurality of legs, or at both ends of each of the plurality of legs.

The connectors for connecting to other robots, components thereof, and/or connection points on the surface may be for securing thereto, for example mechanically or electromagnetically or securing thereto with any other suitable method.

The connectors may be mechanical and/or electromagnetic.

The connectors may also be for laterally connecting the end of the legs at which they are located to an adjacent leg (or end thereof) of another identical robot, which may be adjacent the robot and/or the leg at an end of which the connector is located.

The connectors may be twist-lock connectors.

An electrical connector or inductive charger as described above may be integrated with a connector securing the robot to another robot or the surface as described above.

The drive may be a holonomic drive.

The drive may comprise a plurality of wheels configured to pivot about vertical axes.

The wheels may be omni-wheels, such as mecanum wheels

The wheels may be located on a base of a body of the robot or on ends of extendable legs of the robot.

The wheels may be configured to pivot through at least 180 degrees about the axes.

The drive may be configured to move the robot in at least two perpendicular directions, which may be parallel to edges of a cuboid body of the robot.

The drive may be configured to move the robot across upper surfaces of one or more identical robots.

The robot may comprise rails or tracks on an upper surface of a body of the robot along which an identical robot may be moved using its drive.

The robot may comprise one or more temporarily deployable bridging supports for laterally extending at least part of an upper surface of the robot.

The robot may comprise a wireless communicator, such as a radio, which may be for communicating with other robots and/or a remote control system.

The robot may be configured to communicate information on their contents.

The robot may be autonomous.

The robot may comprise one or more sensors for determining its position and/or movement. These may be the same as, or different to, sensors for determining the position and/or movement of the robot.

The one or more sensors may comprise one or more inertial measurement units, (IMUs), compasses, light detection and ranging (LiDAR) sensor, wheel encoders, and/or external cameras.

The robot may be a container for holding objects.

The container may be an enclosed container.

The robot may define a structural frame for receiving objects.

The robot may comprise one or more sensors for monitoring contents of the container, such as one or more cameras and/or weighing scales. The robot may further comprises a light source for illuminating an interior of the container.

The interior of the container may be refrigerated.

The robot may comprise an opening into an interior of the container on its base, one or more lateral walls, or an upper surface of a body of the robot.

The robot may comprise one or more lateral connectors for connecting a side of the robot to a side of another identical robot, such as connectors for laterally connecting legs of robots as described above.

At least part of the interconnected sidewalls may be openable or removable to interconnect interiors of the robots interconnected by the lateral connectors.

The interconnected robots may be configured such that their lift mechanism cooperate to lift the interconnected robots. When doing so some of the legs of the lift mechanism of the interconnected robots may not be necessary to lift the robots and may not be extended, and/or displaced laterally out of the bodies of their respective robots.

The robot may comprise one or more stacking connectors for connecting a base of the robot to an upper surface of another identical robot, and/or for connecting an upper surface of the robot to a base of an identical robot.

The stacking connector(s) may be located on an upper or lower surface of a body of the robot and/or on an upper or lower end of one or more legs of the lift mechanism.

The connector may be a twist-lock connector.

According to an embodiment, there is provided a system comprising a plurality of robots as described above.

The system may further comprise one or more additional robots without some of the features describe above. For example, the system may comprise one or more additional robots without lift mechanisms, which may be configured to position themselves beneath robots with lift mechanisms in use.

The system may be a centralised, decentralised or hybrid system and/or the plurality of robots may each be autonomous.

Alternatively, the system may be centralised or hybrid system.

Each robot of the system may comprise any of the optional features described above.

According to an embodiment, there is provided a method of operating a multi-robot system, the method comprising a first robot elevating itself relative to a surface and a second such robot moving into a space beneath the first robot, wherein the first and second robots each comprise a drive for moving itself and the first robot comprising a lift mechanism for elevating itself above a surface such that another identical robot is able to move underneath it.

The method may be a method for stacking the first robot on top of the second robot, the method comprising the second robot positioning itself beneath the first robot.

The method may comprise connecting the second robot to the first robot after the second robot positions itself beneath the first robot. For example by lower ends of one or more extendable legs of the lift mechanism of the first robot connecting to upper ends of one or more legs of the lower robot.

The method may comprise the first robot retracting its legs, the second robot deploying one or more legs of a lift mechanism comprised by the second robot, and the lower ends of the legs of the first robot subsequently connecting to upper ends of the legs of the second robot.

The method may be a method for moving the second robot past the first robot, wherein the second robot moves from an initial location to a subsequent location on an opposite side of the first robot via the space beneath the first robot.

The method may comprise the second robot transmitting a signal to the first robot, wherein the first robot elevates itself relative to the surface in response to the signal.

Alternatively, the signal may be transmitted by a third robot or by a central controller.

The signal may be a request to the first robot to elevate itself and/or an indication that the second robot intends to move to or through the location of the first robot.

One or more non-transitory storage media comprising computer instructions executable by a processor of a robot that comprises a drive for moving itself and a lift mechanism for elevating itself above a surface such that another identical robot is able to move underneath it; the computer instructions when executed by the processor causing the robot to elevate itself above a surface.

Referring to the figures generally, there are shown embodiments of robots that are configured to elevate themselves above a surface such that other identical robots are able to move into or through spaces beneath them, as well as embodiments of systems comprising and methods using such robots.

Robots being able to elevate themselves over a surface, such that other robots are able to move underneath them advantageously enables robots to be stacked efficiently without requiring shelving or other infrastructure. Additionally, it allows robots to be lifted out of each other's way to enable robots to reach or leave positions that would otherwise be inaccessible.

Such robots each comprise a drive and a lift mechanism for elevating the robot above a surface. Specific embodiments of such robots, including embodiments described herein, may comprise other optional elements such as interiors for containing and transporting objects, sensors, controllers, radios, batteries, inter-robot connectors, and/or other components providing additional functionality to the robots.

The drive may be for moving the robot over ground surface and may also be for moving over upper surfaces of bodies of other such robots, for example another such robot that has positioned itself underneath the robot after the robot has elevated itself using its lift mechanism. The drive may be configured to move the robot in at least two perpendicular directions, and may be configured to move the robot in any direction and/or to rotate the robot while it remains in the same position. For example, the drive may be a holonomic drive. The drive may comprise a plurality of wheels, such as four wheels, which may be configured to pivot about a vertical axis through their centre, such that in use they can pivot without displacing the robot itself. The wheels may be omni-wheels, such as mechanum wheels. Alternatively or additionally, the drive may comprise other means for moving the robot, such as continuous tracks. In some embodiments, the drive may be configured to engage with and move along one or more rails or guides on the ground surface and/or on upper surfaces of upper robots.

The lift mechanism may comprise one or more displaceable supports, such as a plurality of extending legs; for example, telescopically extending legs. Lengthening and shortening the extendable legs is referred to herein as extending and retracting the legs respectively. Some or all of the extending legs may be configured to be laterally displaced with respect to a body of the robot, into and out of a body of the robot or a footprint of the robot when the legs are not displaced out thereof. Displacing the legs into and out of the body and/or this footprint of the robot is referred to herein as withdrawing and deploying the legs respectively. The footprint of the robot with the legs fully withdrawn may be referred to the movement footprint of the robot, as it may be a footprint occupied by the robot when it moves, such that it can fit between deployed and extended legs of other elevated robots.

The legs being deployed laterally outwards from the body of the robot when they are extended may provide a separation between the extended legs greater than a width of the body of the robot, allowing another such robot to fit between the extended legs beneath the robot. In some embodiments, the legs may laterally shifted outwards from opposite sides or corners of the robot, so as to define gaps between the legs when they are extended through which other robots can move into and out of a space directly beneath the robot.

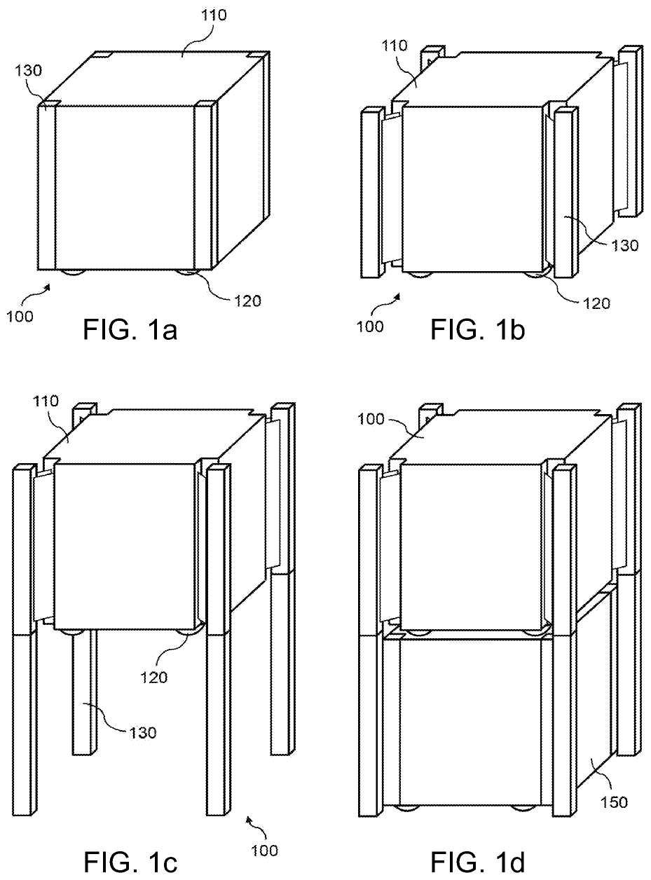

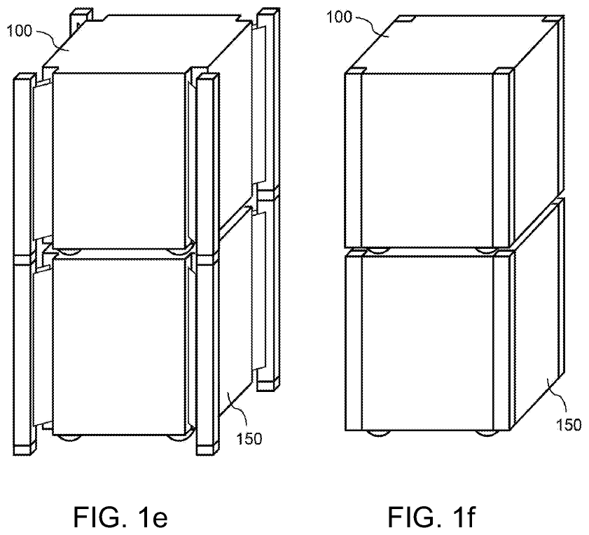

FIGS. 1a to 1d show an embodiment of a robot 100 in un-elevated and elevated configurations. The robot 100 is a container with a cube-shaped body 110 that has an interior for containing and transporting objects. The robot 100 is for use in a system comprising a plurality of identical such robots 100, which may cooperate to stack themselves for storage without requiring infrastructure such as shelving, and/or to lift over each other or out of each other's way during transportation.

The robot 100 comprises a drive for moving itself across a surface on which it is positioned. In the illustrated embodiment, the drive of the robot 100 comprises plurality of wheels 120 on a base of a body 110 of the robot 100. The wheels 120 are configured to pivot around vertical axes through their centres such that the robot 100 can move in any direction without requiring it to rotate its body. This enables the robots 100 to navigate around obstacles and to reach an intended location. When the legs 130 of the robot 100 are un-extended, as shown in FIGS. 1a and 1b, the wheels 120 rest upon a surface, supporting the robot 100 and enabling the drive to move it over the surface.

In the illustrated embodiment, the robot 100 comprises four pivoting omni-wheels 120 on a base of the body 110 of the robot 100 configured to pivot up to 180°. However, in other embodiments, robots may comprise different numbers or types of wheels and/or wheels in different locations. For example, wheels could be provided on the ends of the extendable legs 130, in order to enable the robot 100 to move while elevated with the legs 130 extended.

The lift mechanism of the robot comprises four telescopic extendable legs 130 arranged at corners of body 110 of the robot 100. The legs 130 are laterally displaceable relative to the body 110 of the robot into and out of the body 110 between a withdrawn arrangement, as shown in FIG. 1a, and a deployed outwardly protruding arrangement, as shown in FIG. 1b. When the legs are laterally displaced out of the body 110 into the deployed (protruding) arrangement, they are outside a footprint of the robot 100 with the legs 130 withdrawn, such that another robot 150 with its legs withdrawn can fit between the legs beneath the robot when the legs 130 are extended.

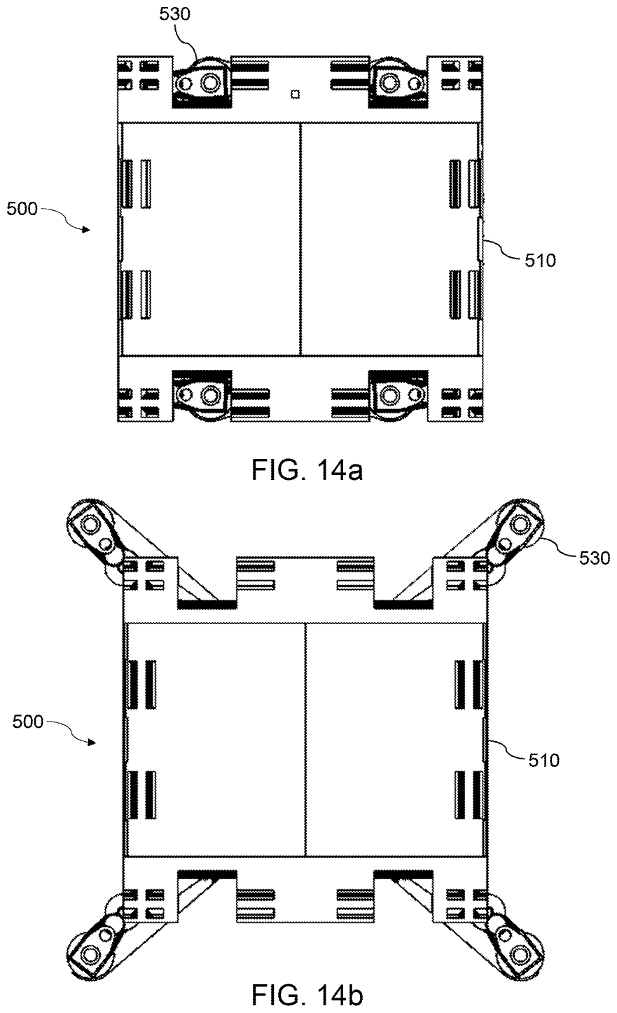

The legs 130 of the robot shown in FIGS. 1a to 1e are displaced into and out of the body 110 of the robot 100 linearly (i.e. in a straight line). In alternative embodiments, legs may be displaced into and out of the body of the robot differently. For example, some or all of the legs of a robot may be rotated out of the body of the robot. In an example embodiment of a robot 500 shown in FIGS. 14a and 14b, the legs 530 of the robot are rotated into and out of the body 510 of the robot about axes parallel to and offset from their lengths. It will be appreciated that a variety of suitable mechanisms may be provided for laterally displacing legs into and out of the bodies of various embodiments of robots as discussed herein (and the footprints thereof).

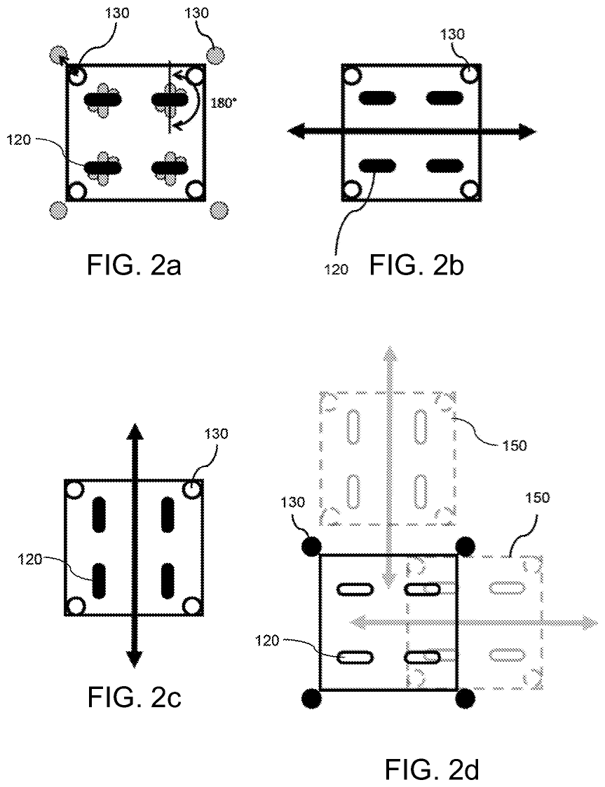

FIG. 2a shows a base-view of the robot 100 showing the range of movement of the pivoting of the wheels 120 and lateral displacement of the legs 130 relative to the body 110 of the robot 100. FIGS. 2b and 2c are base-views of the robot 100 with its wheels in first and second perpendicular directions parallel to different pairs of walls of the body 110 such that the robot is configured to move in first and second perpendicular directions aligned with its walls.

FIG. 1a shows the robot 100 with the legs 130 withdrawn into the body 110 and footprint thereof, and un-extended lengthwise and FIG. 1b shows the robot with the legs 130 laterally deployed out of the body and footprint thereof without being extended lengthwise. FIG. 1c shows the robot with the legs 130 laterally deployed out of the body and footprint thereof and telescopically extended lengthwise to elevate the robot 100 off of a surface. In the figures, the extended portions of the legs 130 are shown as having the same thickness as the remainder of the legs 130, however, it will be appreciated that extending portions of the legs 130 may be narrower than portions from which they extend, for example where the legs 130 are telescopic.

In some embodiments, the legs 130 may be extendable lengthwise only when the legs 130 are deployed out of the body 110, such that elevating the body 110 of the robot 100 requires displacing the legs 130 outwards before extending them. Alternatively, the legs 130 may be extendable lengthwise whether or not they are deployed out of the body 110 and footprint thereof, or are withdrawn within the body 110 and footprint thereof.

In the illustrated embodiment, the legs 130 are displaceable to and from locations within corners of the body 110 of the robot 100, and are configured to shift linearly laterally outward diagonally sufficiently far that the separation between the legs 130 at each adjacent pair of corners is greater than the width of a lateral face of the cube-shaped body 110, thereby enabling another identical robot 150 to fit between adjacent extended legs 130 of the elevated robot when its legs 130 are withdrawn, in order to move into and out of a space directly beneath the elevated robot 100.

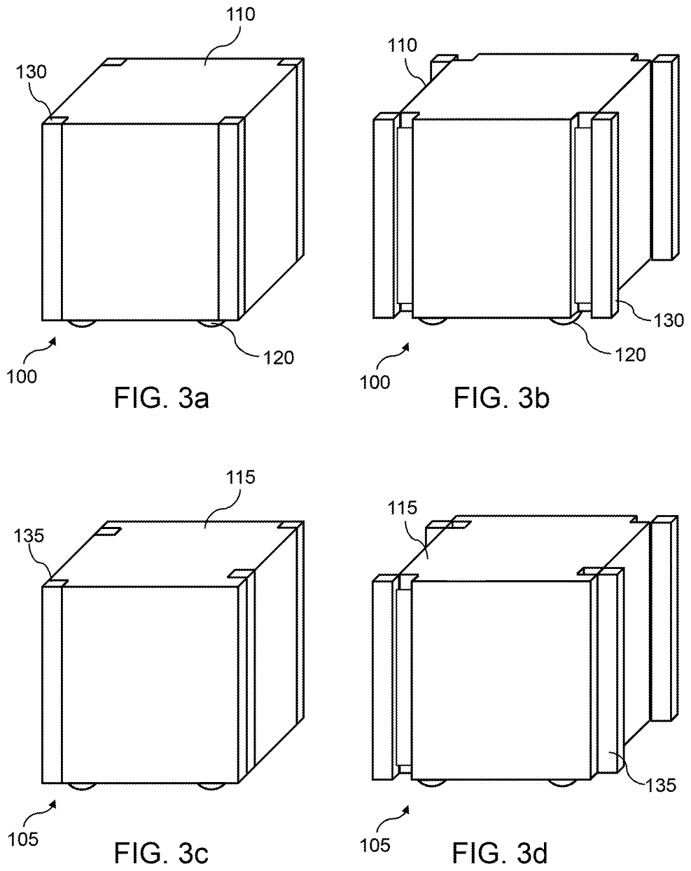

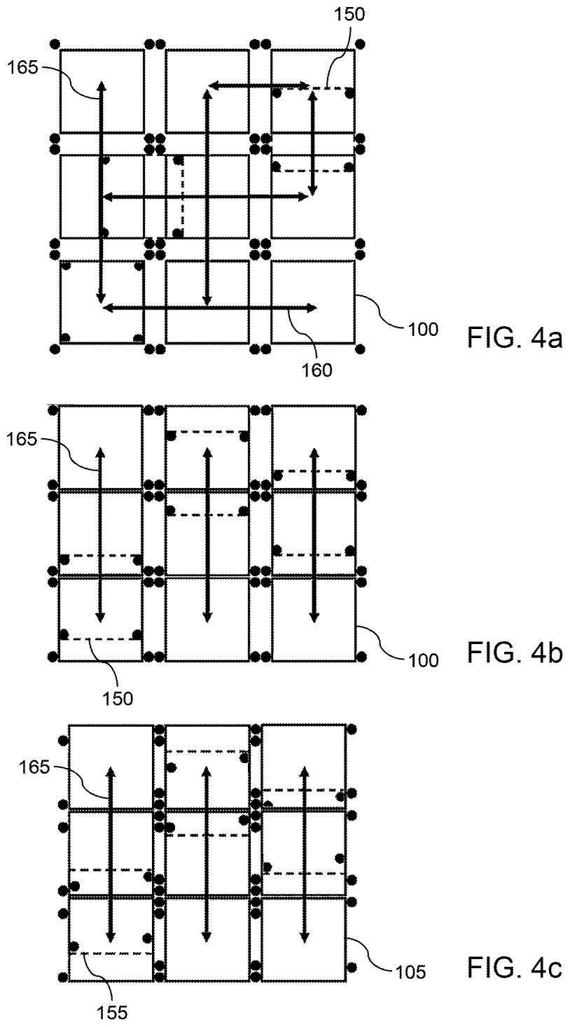

In the illustrated embodiment, and in other embodiments, such as the robot 500 shown in FIGS. 14a and 14b, the legs are configured to be deployed to positions on an extension of a diagonal of the footprint of the robot 100 and offset from the corners of the body 110, at which they do not obstruct any face of the body along an axis perpendicular to that face. In these positions, the legs 130 can be extended such that other robots 150 are able to move into and out of the space beneath the robot 100 from beneath any of the side faces of the body 110 (i.e. in any of four directions, between any pair of adjacent legs). Alternatively, or additionally, the legs of robots may be deployable to other positions, such as positions adjacent a pair of opposite faces of the robot, where they do obstruct some of the faces of the robot. Such deployment configurations are discussed below in more detail with reference to FIGS. 3a to 4c.

FIG. 2d shows a base-view of the robot 100 in the elevated configuration with its legs 130 deployed from its body 110 and extended lengthwise, such that other robots 150 with their legs withdrawn can move between its legs 130 in the first and second perpendicular directions into and out of a space beneath the robot 100.

FIG. 1d shows the robot 100 in an elevated position with its legs 130 extended and deployed laterally outwards from the corners of its body 110, with another identical robot 150, whose legs are not deployed or extended, positioned in a space directly beneath it, for example, having moved into that space through a gap between the legs 130 of the elevated robot 100.

After an identical robot 150 has moved beneath the robot 100, the robot 100 may at least partially retract its legs 130 lengthwise, such that it is supported on its wheels 120 on the upper surface of the other identical robot 150, instead of being supported in an elevated position by its legs 130. FIGS. 1e and 1f show arrangements in which the robot 100 is supported on top of another identical robot 150 and has partially retracted and has entirely retracted and withdrawn its legs 130 respectively.

FIG. 1e shows an arrangement in which the legs 130 of the elevated robot 100 are mostly retracted without being withdrawn and the legs 130 of the other robot 150 are deployed out of its body. The legs 130 of both robots are slightly extended such that the lower ends of the legs 130 of the lower robot 150 contact the floor or other surface on which it is supported, and the lower ends of the legs 130 of the elevated robot 100 contact the upper ends of the legs 130 of the lower robot 150. This may increase the stability of stacked robots 100, 150.

In some embodiments, one, some, or all of the lower ends of the legs 130 of the elevated robot 100 may interconnect with the upper end of the leg 130 of the lower robot 150 that they contact. Alternatively, or additionally, the lower ends of the legs 130 of the lower robot 150 may interconnect with the floor or other surface that they contact. Such interconnections may further increase the stability of the stacked robots 100, 150.

Alternatively, robots 100, 150 could be stacked on top of each other with both of their legs withdrawn, as shown in FIG. 1f. Such an arrangement may be more compact but less stable than the arrangement shown in FIG. 1e.

In some embodiments, instead of—or in addition to—being deployed to positions on an extension of a diagonal of the robot's footprint and offset from the corners of the body, at which they do not obstruct any face of the body along an axis perpendicular thereto, the extendable legs 130 may be configured to be deployed to positions adjacent a pair of opposite faces of the body 110 of the robot 100. For example, the legs may extend directly outward from opposite faces of the body 110 of the robot 100, for example, in a direction perpendicular thereto. In such a deployed configuration, other robots 100 may only be able to fit between legs 130 protruding form opposite faces of the body 110 by moving into the space between the robots from sides from which no legs protrude. However, such embodiments may advantageously allow robots with legs displaced outwards to fit closer together, as faces from which no legs extend can be arranged adjacent each other, without requiring a space therebetween for protruding legs to be located within.

FIGS. 3a and 3b show a robot 100 with its legs 130 withdrawn and with its legs 130 deployed laterally outwards from two opposite faces of the body 110 to positions adjacent the opposite faces. In the illustrated example, the legs 130 are all deployed from corners of the body 110 of the robot in a first direction perpendicular to the face of the body 110 of the robot from which they are deployed.

The robot 100 shown in FIGS. 3a and 3b may be a robot that is only configured to deploy its legs to these lateral positions adjacent the opposite faces, and which is distinct from a robot 100 with configured to deploy its legs diagonally as shown in FIGS. 1a to 1f. Alternatively, the robot 100 shown in FIGS. 3a and 3b may also be configured to deploy its legs diagonally as shown in FIGS. 1a to 1f, such that the robot has two legs-deployed configurations (a diagonal deployed configuration and a opposite-face-adjacent deployed configuration), which may be employed in different circumstances.

When the legs 130 are deployed to positions adjacent opposite faces and extended lengthwise, the separation between the legs 130 in the first direction is large enough for another robot 150 to fit between them when moving in a second direction perpendicular to first direction (i.e. parallel to the faces of the body 110 of the robot 100 from which the legs 130 are laterally deployed). However, when the legs are laterally deployed to these positions adjacent the opposing the faces, the separation between the laterally-deployed and lengthwise-extended legs 130 in the second direction is too small for another robot 150 to fit between when travelling in the first direction. Other robots 150 are therefore only able to move beneath the robot 100 in the second direction (perpendicular to the direction in which the legs are laterally deployed) when the robot's legs 130 are laterally deployed and lengthwise-extended.

When multiple robots have their legs 130 deployed laterally as shown in FIG. 3b, the robots can be packed closer together than when their legs are deployed diagonally as shown in FIGS. 1b to 1e. This is because the faces of the bodies 110 of the robots from which legs are not deployed laterally can be arranged close to, or in contact with each other, without having leave a space for diagonally-deployed legs 130 when aligning the gaps between the legs 130.

FIG. 4a shows a top-down diagram of an arrangement of robots 100 with diagonally-deployed and lengthwise-extended legs 130 showing first and second directions 160, 165 in which other robots 150 with their legs 130 retracted and withdrawn (shown in dashed lines) are able to move beneath them between their legs 130. In this configuration, the bodies 110 of the robot occupy approximately 65% of the footprint of the area in which the robots 110 are located.

FIG. 4b shows a shows a top-down diagram of an arrangement of robots 100 with their legs 130 deployed to positions adjacent a pair of opposite faces and lengthwise-extended. The diagram shows that other robots 150 with their legs 130 retracted and withdrawn (shown in dashed lines) are able to move beneath the elevated robots 100 only in a second direction. In this configuration, the bodies 110 of the robot occupy approximately 79% of the footprint of the area in which the robots 110 are located, thereby providing improved space efficiency.

In the robot 100 shown in FIGS. 3a and 3b, the legs are deployed to the positions adjacent the opposite faces linearly (i.e. in a straight line). It will be appreciated that in alternate embodiments, legs may be displaced to these positions differently, for example by rotating them about an axis parallel and offset from their lengths. The legs 530 of the robot 500 shown in FIGS. 14a & 14b, may be deployable to positions adjacent a pair of opposite faces of the body of the robot 500 by rotating them from their withdrawn positions by 90° instead of 135° as shown in FIG. 14b.

FIGS. 3c and 3d show an alternative embodiment of a robot 105 configured to laterally deploy two legs 135 to positions adjacent ends of a pair of opposite sidewalls of the robot's body 110 at a pair of opposite corners of the robot 105, and two other legs 135 to adjacent points part-way along the two opposite sidewalls. In such deployed configuration, the nearest legs of multiple robots arranged side-by-side may be offset, enabling the robots to be positioned closer together.

In the example robot 105 shown in FIGS. 3c and 3d, instead of all four of the legs being deployed from the corners of its body (as in the robots 100 shown in FIGS. 1a to 3b), two legs 135 are deployed laterally from opposite corners of its body 115 in a first direction, and two other legs 135 are deployed laterally in a first direction from positions part-way along the two sidewalls of the body 115 that extend in a second direction perpendicular to the first direction. However, it will be appreciated that the exact positions of the legs and the directions in which they are deployed could be varied in different robots as long as the legs that are positioned part-way along the two side walls of the body 115 are separated from the corners to such an extent that, in their extended position, they leave enough space to accommodate a leg of an adjacent robot that has been extended from a corner of the adjacent robot's body 115.

When the legs of a such robot 105 are deployed and extended, other robots 150 with their legs withdrawn and retracted would be able to move beneath the robot in a direction parallel to the two opposite walls from which the legs are laterally deployed.

As only two of the legs 135 are deployed to opposite corners of the body 115 of the robot 105, robots as shown in FIG. 3d are able to be positioned closer together with their legs deployed while aligning their edges to facilitate the movement of other robots 155 beneath them.

FIG. 4c shows a top-down arrangement of a plurality of robots 105 as shown in FIG. 3d. Similarly to the arrangement shown in FIG. 4b other robots 155 with their legs 130 retracted and withdrawn (shown in dashed lines) are able to move beneath the elevated robots 100 only in a second direction 165 perpendicular to the first direction in which legs are displaced when they are deployed. The robots 105 which do not have all four of their legs 135 at their corners are able to be positioned closer to each other in this arrangement, making it more space efficient than the arrangement shown in FIG. 4b. In this configuration, the bodies 110 of the robot are able to occupy approximately 88% of the footprint of the area covered by the arrangement of robots.

In the robot 100 shown in FIGS. 3a and 3b, the legs are deployed to the positions adjacent the opposite faces linearly (i.e. in a straight line). It will be appreciated that in alternate embodiments, legs may be displaced to these positions differently, for example by rotating them about an axis parallel and offset from their lengths. For example, a robot 500 as shown in FIGS. 14a & 14b may be deployed to an offset laterally-deployed configuration by rotating two of its legs 530 from their withdrawn positions at a pair of opposite corners by 90° and rotating the other two legs 530 from their withdrawn positions by 45°.

The robot 105 shown in FIGS. 3c and 3d is an alternative robot to robots 100 as described above with reference to FIGS. 1a to 3b. However, it will be appreciated that alternate embodiments could combine the functionality of the robots 100 of FIGS. 1a to 3b with the functionality of the robot 100 of FIGS. 3c and 3d, for example by comprising six legs (four in corners and two part-way along sidewalls of the body) or by using legs 530 configured to be deployed rotationally to different angles as described with reference to the robot 500 shown in FIGS. 14a and 14b.

The alternate robots 100, 105 described with reference to FIGS. 3a to 3d may comprise any of the suitable optional features described herein with reference to the robot shown in FIGS. 1a to 1f.

Robots 100 may comprise a single actuator for displacing and/or extending all of their plurality of legs 130 or multiple synchronized actuators for displacing and/or extending their legs 130, such as an individual actuator for extending each leg 130. This may ensure that the legs are extended equal amounts, and the robot 100 is kept horizontal as it is elevated and lowered. Using only a single actuator may reduce the overall complexity, cost and/or weight of the robot. The one or more actuators may be linear actuators, and/or may be electric, hydraulic or pneumatic. The robots 100 or actuator(s) thereof may comprise a locking mechanism for locking the legs in an outwardly shifted and/or extended configuration, which may reduce energy consumption of the robot 100 by not requiring the actuator to be active. Such one or more actuators may be located within one or more faces, one or more legs, and/or base of the robot.

In some embodiments, the extendable legs 130 of a robot 100 may only be configured to extend when they protrude out of the body 110 and/or footprint of the robot 100. In other embodiments, the legs 130 may be extendable when withdrawn into the body 110 and/or footprint thereof. When legs 130 are extended while withdrawn in this manner, the robot 100 may be elevated without enabling an identical robot to fit between its extended legs 130.

In some embodiments, some or all of the extendable legs 130 may be flush with, and/or may define parts of, lateral faces of the body 110 of the robot when they are not deployed out of the body 110 or footprint of the robot 100. In the illustrated robot 100, the legs 130 are generally cuboid and have an un-extended length equal to a height of the body 110 of the robot 100, such that they define corners of the body 100 when withdrawn. However, in alternative embodiments, legs may have other configurations. For example, the legs may be cylindrical, may be withdrawn entirely within the robot body, and/or may have un-extended lengths less than the height of the body. The legs may be designed to be as slim as possible while supporting a predetermined weight. The predetermined weight is, as a minimum the total, fully loaded weight of the robot 100. In other embodiments, the predetermined weight is a multiple of the fully loaded weight of the robot 100, enabling the robot 100 to not only lift itself in the manner described above but also to lift one, two or many other robots that are already stacked on top of and/or connected to the robot 100 in a single lifting action.

As described above, the lift mechanism of a robot 100 enables other robots to move into and/or be located within a space beneath the body 110 of the robot 100, thereby enabling multiple robots 100 to stack on top of each other. In some embodiments, robots 100 may comprise one or more connectors for releasably connecting to other robots, such as other identical robots, located above and/or below them. Such connectors may allow robots 100 to more securely stack upon each other, and/or may enable multiple interconnected robots 100 stacked on top of each other to be elevated by a single lift mechanism of one of the interconnected robots 100. Such connectors may be mechanical and/or electromagnetic.

Such one or more connectors may be located on an upward facing part of the robot 100 (such as on upper ends of one or more of the legs 130 and/or on an upper face of a body 110 thereof) for connecting to another robot above, or on a downward facing part of the robot 100 (such as on lower ends of one or more of the legs 130 and/or on a lower face of a body 110 thereof) for connecting to another robot below.

In some embodiments, connectors may be arranged on upper and/or lower ends of one, some, or all of a plurality of extending legs 130 of the robot 100. Such connectors may be configured to connect to ends of legs of other robots 100. In some such embodiments, the connectors on ends of legs 130 of the robot 100 may be configured to connect to the ends of legs 130 of other robots when the legs 130 of both the robot 100 and the other robot project out of the bodies 110 or footprints thereof, and/or when the legs of the robot 100 and the other robot are both withdrawn within their bodies 110 or footprints thereof.

Alternatively, or additionally, one or more connectors could be arranged on sideways facing parts of the robot 100 for connecting to extended legs 130 of another robot above, which extend down around and/or adjacent the robot 100.

Some or all of the connectors may be configured to connect to corresponding connectors on other robots (for example, in embodiments in which robots 100 comprise one or more connectors on a top and on a bottom thereof). Alternatively, or additionally, some or all of the connectors may be configured to connect to other parts of another robots, such as to parts of the legs 130 and/or body 110 thereof.

The connectors may be configured to connect the robot 100 to another robots such that the interconnected robots 100 are aligned. For example, such that footprints of the robots coincide when viewed along an axis normal to their footprints, such as a vertical axis where the robots stand upon a horizontal plane. The connectors may be mechanical, mating, electromagnetic, interlocking, and/or interference fit connectors.

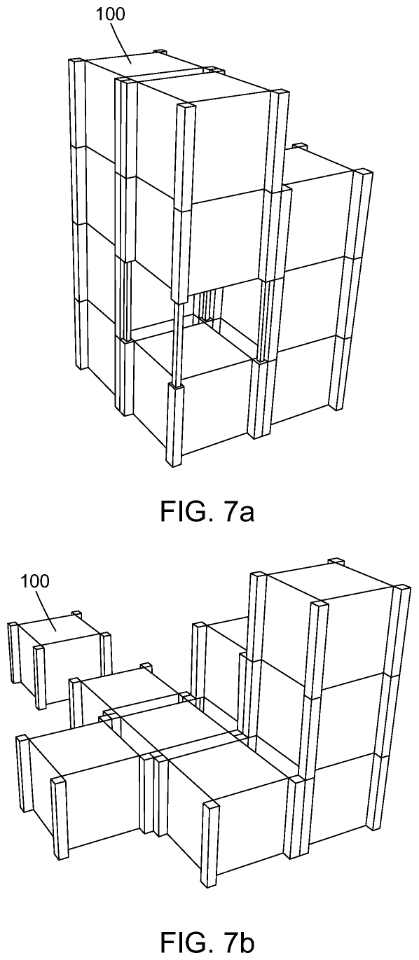

In some embodiments, the connectors at ends of the legs 130 may be configured to connect laterally to other robots and/or ends of legs thereof that are located beside the robot 100 and/or extended legs thereof. For example, connectors at upper ends of the legs 130 of the robot 100 may be configured to connect to upper ends of the legs of other identical robots, and/or connectors at lower ends of the legs 130 of the robot 100 may be configured to connect to lower ends of the legs of other identical robots. Connecting adjacent robots in this manner may increase the stability of a group of adjacent robots, such as group consisting of multiple adjacent stacks of robots, as shown in FIG. 7a, where upper and lower ends of legs of the robots are aligned with each other and arranged side by side. Such connectors may disconnect such lateral connections to another robot when that other robot, or another robot stacked above or below it, extends or retracts its legs.

As described above, robots may be configured to move over upper surfaces of other robots, such as another robot that has beneath a robot after it has elevated itself above a surface as described above. The upper surfaces of bodies of such robots may be suitable for other robots, such as other identical robots, to move across them using their drives. For example, their upper surfaces may be flat and/or capable of supporting the weight of other robots.

In some embodiments, robots 100 may comprise one or more rails, tracks, or guides 180 on the upper surfaces of their bodies 110 for other robots to travel along. Such tracks, guides, or rails may be parallel to edges of the upper surface, and in some embodiments may extend in two perpendicular directions. The rails or tracks of a first robot 100 may be arranged such that a second robot travelling over the first robot with its wheels 120 on the first robot's rails or tracks will have edges parallel to its direction of travel that aligned directly above the parallel edges of the first robot. This may enable robots 100 to move along the rails of tracks of adjacent robots between positions where their footprints coincide with robots beneath them when viewed along an axis normal to their footprints. FIG. 6 shows an example of an upper surface of a robot 100 comprising such tracks or rails 180.

In some embodiments, robots moving on upper surfaces of lower robots may be restricted to movement in directions parallel to lateral faces of the lower robots, for example, by rails or tracks as described above.

However, the robots may be free to move in any direction on any flat surface, which may include a surface defined by upper surfaces of a plurality of other robots. The robot (or some or all of a plurality of robots of a multi-robot system) may therefore not include rails, guides, or tracks as discussed above.

A plurality of robots 100 with extendable legs 130 deployed out of their bodies 110 and/or footprints may not be capable of being arranged directly adjacent to each other such that there are not gaps between their upper surfaces. When such robots are arranged together with their legs deployed in this manner there may be gaps between the robots 100 which robots moving on top of their upper surfaces as described above may be intended to cross.

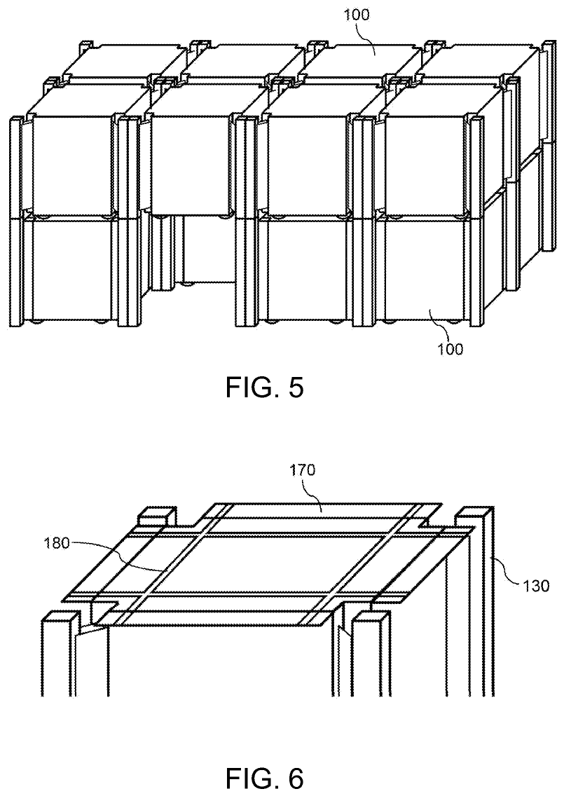

For example, FIG. 5 shows a plurality of robots 100 that comprise diagonally-outwards-deploying legs 130 packed together. The robots 100 are stacked in two layers in a regular grid pattern, such that the faces of adjacent robots are parallel and aligned with each other. The robots 100 of the upper layer have their legs 130 protruding outwards from their corners and lengthwise extended in order to elevate themselves above a surface, and the robots in the lower layer have their legs withdrawn in order to enable them to fit between the extended legs 130 of the upper robots 100. The gaps between the extended legs 130 of the robots 100 in the upper layer are aligned such that robots 100 without their legs 130 deployed are able to move between them within the lower layer. In this arrangement, each adjacent robot is separated by a gap of width equal to twice the thickness of one of their extendable legs 130.

While the group of stacked robots shown in FIG. 5 only comprises two levels, in other systems and/or situation, robots may be stacked in more than two levels, for example as shown in FIGS. 7a and 7b.

In the group of stacked robots 100 shown in FIG. 5, the robots 100 in the upper layer, which are positioned directly on top of other robots 100 in the lower layer, have their legs 130 deployed and extended, and the robots 100 in the lower layer have their legs 130 withdrawn, in the same manner as the two stacked robots shown in FIG. 1d. This enables the robots 100 in the lower layer to move out from beneath an elevated robots 100 stacked on top of them without waiting for it to deploy and extend its legs 130.

However, in other systems and/or situations, some or all of the robots 100 positioned beneath other robots 100 may have their legs 130 deployed. The deployed legs of these robots may be slightly extended to contact a surface on which these robots 100 are supported.

In some embodiments, all of the robots in a group of stacked robots may have their legs deployed. FIGS. 7a and 7b show two examples of groups of stacked robots in such embodiments. In such embodiments the legs may all be slightly extended downwards to be level with the bottoms of the wheels of their robots, in the same manner as the two stacked robots shown in FIG. 1e. The legs of robots stacked on top of each other may be interconnected to increase the stability of the stacked robots.

In such embodiments, robots 100 within the stacked group may laterally change position by disconnecting and withdrawing their legs, enabling them to move between extended legs of other robots. In some situations, other robots may extend their legs to elevate themselves out of the way of the robot changing its position.

In some embodiments robots without their legs 130 deployed (for example unelevated robots) may also be arranged with such gaps between them, in order to enable them to deploy their legs 130 if they are to elevate themselves, for example if other robots are to position themselves in the same area requiring the robots 100 to stack on top of each other.

In some embodiments, robots may comprise temporarily deployable bridging supports 170 for spanning such gaps between their upper surfaces, in order to enable other robots to travel across their supper surfaces. Such bridging supports 170 may comprise flaps or lips for laterally extending their upper surfaces, and/or extendable portions or tracks or rails as described above. FIG. 6 shows an example of an upper surface of a robot 100 comprising such bridging supports 170.

Such bridging supports 170 may be continuously deployed when their robot 100 is deployed such that it defines part of a surface, or may be temporarily deployed when another robot needs to cross a gap to or from the upper surface by which they are comprised. In some such embodiments, robots 100 may be configured to communicate with robots over whose upper surfaces they are travelling in order to cause them to deploy necessary bridging supports 170 to span gaps in the communicating robots intended path.

It will be appreciated that alternative configurations to the bridging supports shown in FIG. 6 may be provided. For example, robots 100, 105 as shown in FIGS. 3a to 3d may only comprise bridging supports that extend on the sides from which their laterally deploying legs are deployed (as their other sides may be positioned directly adjacent other robots, as shown in FIGS. 4b and 4c).

Alternatively, or additionally, some or all of the robots 100 may be configured to cross gaps between robots as described above, for example by comprising larger wheels or continuous tracks.

Each robot 100 may comprise various electronic components, including but not limited to one or more controllers, batteries, external sensors, position and/or location sensors, communicators such as a radios, internal sensors, internal lights, and/or external lights.

In some embodiments, a robot 100 may comprise a rechargeable batteries, and in some embodiments may be configured to charge its rechargeable batteries through one or more of its extendable legs 130, such as through an electrical connector or inductive charging means at a lower end thereof. Such a lower end of a leg may be configured to receive electrical energy from an electrical connection or inductive charging means in a ground surface which the robot is supported on (for example, when the robot is supported in an elevated position by extended legs). Additionally, a robot 100 may comprise an electrical connection or inductive charging means in an upper end of one or more legs of its legs 130 via which it may provide electrical energy to another robot whose legs' lower ends contact or connect with the upper ends of the legs 130 of the robot, such as in the configuration shown in FIG. 1e. Such batteries may be replaceable, optionally automatically replaceable, for example in order to allow rapid changing of batteries to eliminate any intermediate charging time.

Robots may comprise one or more position and/or orientation sensors for tracking the position of the robot. For example robots may comprise an inertial measurement unit (IMU), a compass, and/or one or more gyroscopes. Alternatively, or additionally, robots may track their positions through observations of their environment, and/or through communications with other robots and/or devices. For example, robots may determine their locations based on distances to a plurality of stationary anchors with which they communicate.

Robots may comprise one or more external sensors for monitoring their external environments, which may be used to detect obstacles and/or other robots. For example, robots may comprise one or more Light Detection and Ranging (LIDAR) sensors and/or cameras. Such sensors may be used to identify whether a movement will be unobstructed before it is executed.

Robots may comprise one or more internal sensors for monitoring contents of an interior of the robot. For example, the robot may comprise a weighing scale for measuring the mass of the contents and/or a camera for monitoring contents of the interior of the robot. Robots may comprise one or more internal lights for illuminating the interior, which may be visible or infra-red lights, for example, where the robots comprise an internal camera and a fully enclosed interior space for objects. A robot may comprise a temperature sensor for monitoring the temperature of its interior space and/or contents thereof. The interior of the robot for objects may be refrigerated, for example to enable the robot to transport pharmaceutical products and/or perishable foodstuffs.

Robots may comprise one or more communicators, such as radios, for communicating with other robots and/or remote devices such as anchors for localising the robot, or central controllers. Robots may communicate with other robots or remote devices to receive instructions, to transmit information on its contents, to receive information on the positions or arrangements of other robots, to request other robots move and/or lift themselves out of its path, and/or to request other robots over which it is moving or intends to move deploy bridging supports as described above. Such communicators may enable the robots to wirelessly access an external public or private network, or to access the internet.

Robots may comprise controllers, such as onboard controllers, which may comprise one or more processors, memories and/or one or more communicators as described above. Such a controller may enable a robot to communicate with other robots, to make decisions and to execute actions, either individually or collaboratively with other robots. In some embodiments, each robot may have a unique ID and/or may be identifiable and/or trackable.

Robots may be configured to determine whether moving, positioning, elevating, and/or lowering themselves (and/or deploying or withdrawing their legs) is feasible and/or appropriate before doing so. For example, robots may evaluate whether their current location is adequately supported for them to elevate themselves, or whether a potential destination is adequately supported for them to move to (for example, where the robot is supported on another's upper surface, whether another robot is available for it to move on top of in a given direction). Such evaluations may be based on the robot's weight and/or the weight of other robots stacked on top of it and/or connected to it. Alternatively, or additionally, robots may evaluate whether they are correctly aligned with one or more other robots (beside, below, and/or above them), for example before positioning, deploying their legs, and/or elevating themselves. Robots may only be correctly aligned in a grid arrangement as shown in FIGS. 5, 7a, and 7b. If a robot evaluates that a given action is not feasible, such an action may not be executed, this may be communicated to other robots and/or to one or more central controller(s) to facilitate organisation of a multi-robot system.

Robots may monitor and/or be informed of their contents, and may communicate said contents to remote users and systems, such as user or systems with access rights, for example, in response to queries and requests. For example, this may enable a user to determine how many robots hold a specific item and/or how many of said objects are stored between all of the robots.

The illustrated robot 100 comprises a cube-shaped body 110 with its legs 130 retracted, for use in a system of a plurality of such robots 100. The cube-shaped body may allow the robots to be packed tightly together and stocked on top of each other, and to define uniform multi-robot structures. In other embodiments, some or all of the robots comprised by a system may comprise other shapes and/or sizes. For example, systems may comprise one or more cuboid-shaped robots. Robots may be built to application-specific sizes and/or shapes.

Each robot 100 may comprise an enclosed or substantially enclosed interior, within which objects may be located to be stored and/or transported. Each robot 100 may comprise one or more doors, lids, hatches, or other openings into its interior where objects may be stored in use, such openings may be located in any lateral face of the body 110, and/or in an upper surface and/or a base of the body 110. In some embodiments, a robot 100 may comprise an actuated opening in its base, allowing the robot 100 to deposit its contents into a space, container, and/or another robot located beneath the robot.

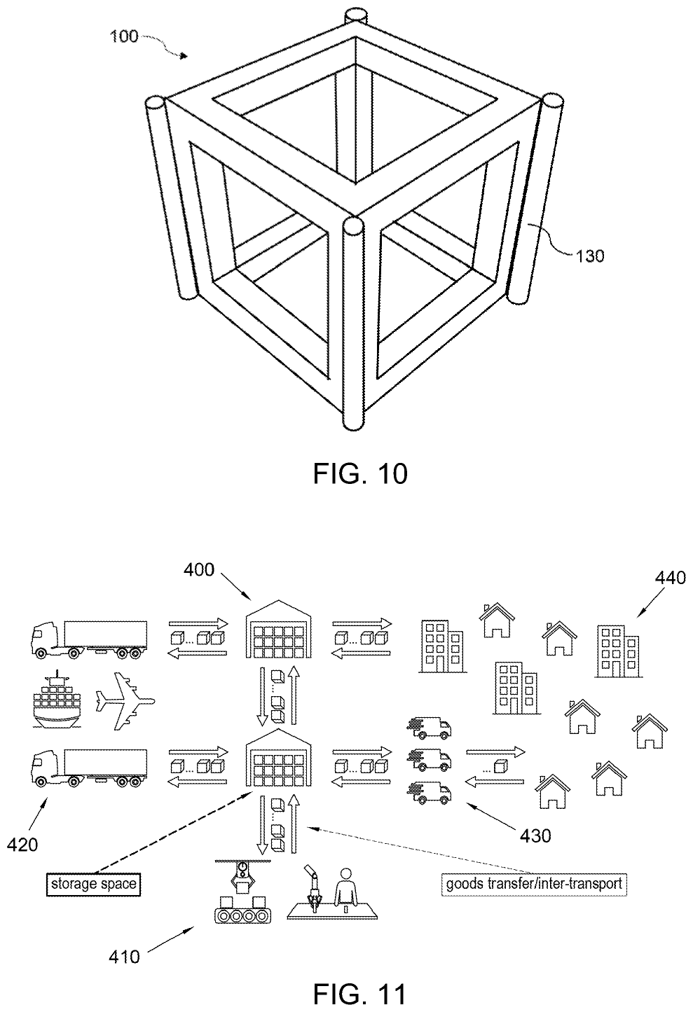

In other embodiments, the robot may not comprise an enclosed interior. Instead, the robot may comprise a structural frame within which objects may be positioned in use. FIG. 10 shows an example of such a robot comprising a cuboid structural frame for receiving objects.

In some embodiments, a robot may comprise a conveyor, extending fork, or other mechanism for displacing objects into and out of its body. For example, a robot as shown in FIG. 10 may comprise an extending fork for loading and unloading a shipping pallet from its interior.

In some embodiments, a robot may comprise one or more side connectors, for releasably connecting it side-to-side with another adjacent robot, such as another identical robot. Connecting to other robots in this manner may increase the stability of a structure of interconnected robots, and/or may enable a plurality of robots to define a larger container by interconnecting their interiors, via opening doors in their interconnected sidewalls, and/or by removing all or part of their interconnected sidewalls. In some embodiments such side connectors may be located on the legs of the robot and/or on side faces thereof.

In an embodiment, side connectors on the bottom corners may be located on the legs of the robot. In some embodiments, such side connectors may be defined by the same connectors as for connecting to robots located above and/or below the robot. For example, the connectors may be twist-lock connectors which enable connecting to other twist-lock connectors in multiple directions. Twist-lock containers are used to interconnected intermodal shipping containers to define structurally stable and safe clusters of containers.

A robot may comprise one or more replaceable and/or removable sidewalls or parts thereof. Such sidewalls may be removed to allow larger objects to extend out of the interior of the robot, and/or when the robot is interconnected side-to-side with another robot as described above, in order to interconnect the interiors of the robot to form a single larger container, enabling the robots to carry objects whose size of shape may prevent them from fitting within a single robot.

The body of each robot 100 may be rigid and strong enough to support one or more other robots (which may contain contents) resting upon it, and to withstand intermodal transport and storage stresses. The rigidity and strength of a robot may be primarily incorporated in edges of the body 110 of the robot 100, in order to allow one or more walls of the body to be removed.

The robot 100 may be dimensioned to have a width, depth, and/or height equal to an integer fraction of the interior of an intermodal container (such as the 5.867×2.330×2.350 meter interior of an ISO 20-foot intermodal container) with and/or without its legs 130 deployed, in order to enable a plurality of such robots to efficiently fill the interior of such a container. Alternatively, robots as described herein, or configurations of multiple such robots may be used in place of such containers.

The dimensions of robots 100 and/or components thereof may depend upon their use cases and/or industry requirements or standards. Robots 100 may be built with different application-specific and/or standardised dimensions. In some embodiments, different sizes of robots 100 may be provided, for example including smaller robots 100 configured and dimensioned to move into, position themselves within, and/or connect themselves to the interior of, other larger robots 100.

According to further embodiments there are provided systems comprising a plurality of robots 100 as described above, which may be used to store and transport objects. Such systems may use the self-lifting capabilities of the robot to efficiently stack multiple robots in a relatively small area without requiring infrastructure or outside assistance, and/or may enable to lift over each other or out of each other's way as robots 100 move from one location to another. Any individual robot 100 of the system may comprise any of the optional features described above.

Such systems may flexibly and efficiently use currently available 3D space to store goods, objects and/or material inside robots as described above and/or interiors thereof. These robots may define self-moving boxes and/or containers and may stack themselves on top of each other to form 3D structures, without requiring pre-existing and/or bespoke infrastructure. Such systems are therefore adaptable to varied or changing environments, for example, in areas with no bespoke shelving, with changing layouts, and/or in which storage areas serve different purposes and/or use cases at different times, and may allow potentially valuable space to be used for multiple purposes. Such systems may flexibly store objects in a distributed fashion wherever space is available and/or close to where contents may be required, for example, where the objects are required most frequently, and may thereby facilitate agile just-in-time manufacturing and/or lean production, as stored objects and be requested flexibly and delivered in minimal time from nearby robots.

Systems may be modular to allow the number of robots comprised by the system to be varied. This may allow the system to be scalable to a variety of different use cases, and/or to changing or expanding environments.

Additionally, such systems may be used to transport objects, for example, replacing existing solutions in which objects being transported are passed between different handlers and/or storage means in different stages of transportation. For example, robots of the system may move between different rooms and/or buildings of a facility, and/or may load and/or unload themselves from vehicles. Such systems may remove the requirement of intermediate robotic systems or humans to transport passive non-robotic containers between locations, facilities and/or vehicles. Therefore, a system of self-moving and self-stacking robots as described herein can replace a system in which passive containers and/or parcels are moved by robots and/or bespoke equipment. Additionally, such robots may load and/or unload themselves from vehicles or storage locations in a parallel fashion rather than a traditional sequenced order. The system may therefore dramatically increase the efficiency of transporting and retrieving objects.

In some embodiments, some or all of the robots of the system may be configured to be partially or entirely autonomous and/or the system may be decentralized, without a controller or other means controlling or defining the behaviour of the robots 100. Individual robots may operate based on local information and/or interactions (such as communications with other robots 100). Alternatively, or additionally, the robots and/or the multi-robot system may be configured to work with, or to use or include a central controller, which may provide a centralised control system, or a hybrid centralized-decentralized system. A central or hybrid control system may coordinate the movements of some or all of the robots and/or may send computed optimal movements to be executed by the plurality of robots.

One or all of the robots may each be configured to determine actions to perform based on observations of, and/or received information on, their surrounding environment, the positions of other robots, tasks it is to perform and/or tasks being performed by other robots. For example, some or all of the robots may be configured to determine when to elevate themselves, to request other robots elevate themselves, and/or to perform one or more steps of methods described below based on one or more of these factors.

The system may additionally comprise a higher-level centralised control means which may collect data, manage the robots and/or deploy updated software or parameters to the robots, for example to optimise their performance.

Such features may enable decentralised and/or centralised control of the robots, enabling them to form a cyber-physical system and or an Internet of Robotic Things system.

The multi-robot system may be configured to perform embodiments of methods comprising a first robot elevating itself above a surface and a second such robot moving into a space beneath the first robot.

Methods may be stacking methods for positioning the second robot beneath the first robot in order to stack the first robot on top of the second robot, or may be tunnelling methods for the second robot to move from one side of the first robot to another via the space beneath the first robot.

The surface may be a ground surface or may be a surface defined by upper surface of a plurality of adjacent robots, such as robots packed together as shown in FIG. 5.

Embodiments of a stacking method may comprise a first robot in a first location on a surface elevating itself relative to the surface using its lift mechanism, and a second robot moving from a second location on the surface to the first location and positioning itself beneath the first robot.

The stacking method may be performed when the first and second robot are to be positioned in the same location (which may be or may comprise the first location).

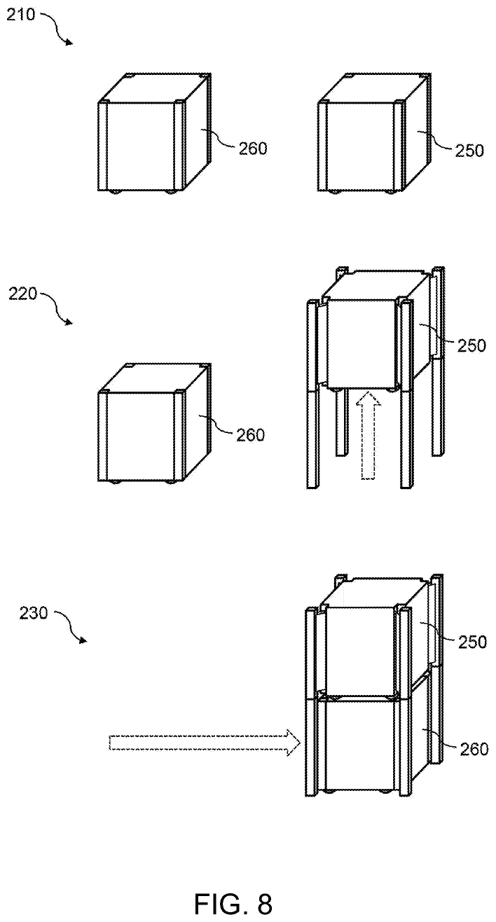

FIG. 8 shows three sequential stages 210, 220, 230 of a stacking method. In a first stage 210 of the method, a first robot 250 is positioned in a first location on a surface and a second robot 260 is positioned in a second location on the surface. In a second stage 220 the first robot 250 elevates itself above the surface in the first location by deploying and extending its legs, thereby creating a space beneath it for another robot to fit within. In a third stage 230, the second robot 260 moves from the second location to the first location through the legs of the first robot 250 and positions itself beneath the first robot 250.

While the second robot 260 is shown as moving to the first location in a separate subsequent stage after the first robot elevates itself, it will be appreciated that the second robot 260 may begin to move towards the first location while the first robot 250 is elevating itself.

The stacking method may further comprise the robot moving to the first location before elevating itself. In some such embodiments, the second robot may be located in the first location before the first robot, and the method may comprise the second robot moving away from the first location to the second location, before the first robot moves to and elevates itself at the first location, such that the second robot can move back to the first location beneath the first robot. This may be performed when first robot is to position itself in the same location as the second robot, and it is expected that the second robot is more likely to need to leave the location before the first robot than vice versa.

When the first robot 250 elevates itself it may also lift one or more other robots stacked above it. Such other robots may be freely stacked on top of the first robot 250 or may be interconnected in a stack, such as by connectors comprised by the robots. Alternatively, or additionally, the first robot 250 may also lift one or more other robots stacked beneath it and connected to it.

In the example shown in FIG. 8 the first robot 250 elevates itself from an un-elevated arrangement in the first location without its legs extended. However, in other embodiments of stacking methods, the first robot may instead further elevate itself from an already elevated arrangement in the first location. For example, if the first robot is the uppermost robot of a stack of interconnected robots in the first location, the first robot may further elevate itself by further extending its legs, thereby lifting itself, as well as the other robots stacked beneath it and connected to it off a base surface, thereby providing space for the second robot to fit beneath the lifted robots, defining a new lowermost robot of the stack in the first location.

The method may further comprise the second robot connecting to the first robot, or of another lowermost robot in a stack of robots connected to the first robot, after the second robot has moved to the first location and positioned itself beneath the first robot, for example, by interconnecting their legs as shown in FIG. 1e. For example, the method may comprise the first robot retracting its legs, the second robot deploying its legs, and the lower ends of the legs of the first robot subsequently connecting to upper ends of the legs of the second robot.

In some embodiments the method may comprise the first and second robots communicating with each other. For example, the second robot may transmit a signal to the first robot indicating that it is also to position itself in the first location, which may trigger the first robot to elevate itself. In some embodiments, the first and second robots may communicate with each other to determine which is to stack on top of the other. In some embodiments, the first robot may only elevate itself if it determines that doing so is feasible, for example if it is adequately supported by a surface or one or more other robots below it.

In some embodiments, the method may further comprise the second robot 260 elevating itself above the surface in the first location by deploying and extending its legs, thereby lifting the first robot 250 stacked on top of it, and creating a space beneath it for another robot to fit within. A third robot may then move to the first location through the legs of the second robot 260 and position itself beneath the stacked first and second robots 250, 260. These steps may be repeated additional times with fourth, fifth and further robots to increase the number of robots stacked on each other. A maximum number of robots which may stack on each other may depend on, be determined based on, or be pre-set based on a maximum weight that can be placed on any one robot, a maximum height at which a stack of robots may be stable, a maximum weight that can be lifted by extending the legs of the lowermost robot of the stack, and/or a maximum weight that can be supported by the legs of the lowermost robot in an extended and locked configuration. It will be appreciated that a maximum weight that can be stacked on top of the robot whilst the robot is not required to lift the weight may be far higher than the weight stacked on the robot that is also required to be lifted by the robot.

Methods may be tunnelling methods for a second robot to move from one side of a first robot to another via the space beneath the first robot.

Embodiments of a tunnelling method may comprise a first robot in a first location on a surface elevating itself relative to the surface using its lift mechanism, and a second robot moving from a second location on the surface to the first location to a third location on the surface via the first location beneath the first robot.

The tunnelling method may be performed when the second robot is required to move to a location on an opposite side of the first robot, and/or when no path is available between the second location of the second robot its destination that is not obstructed by one or more other robots.

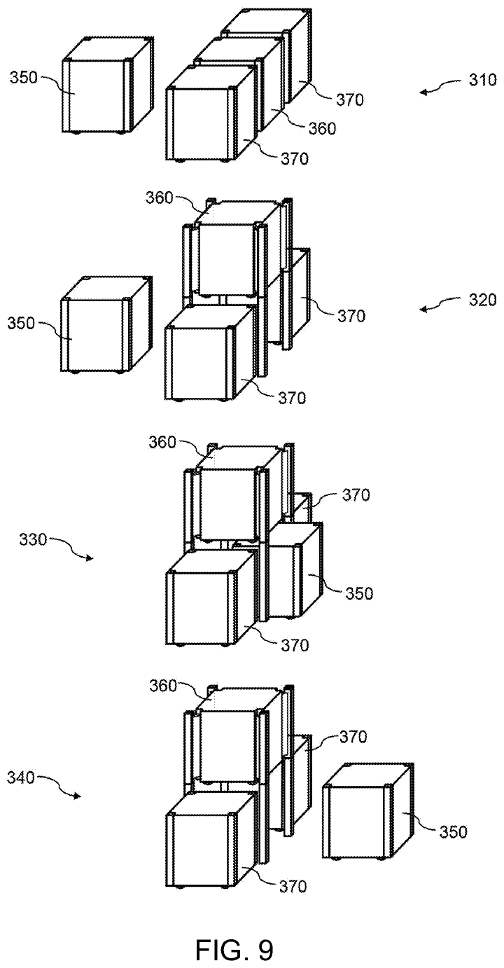

FIG. 9 shows four sequential stages 310, 320, 3re30, 340 of a tunnelling method. In a first stage 310 of the method, a first robot 360 is positioned in a first location intermediate two third robots 370. The first robot 360 and two third robots 370 together blocking a route from a second location, at which a second robot 350 is positioned, and a destination of the second robot 350 at a third location. While only the first, second and third robots 350, 360, 370 are shown in FIG. 9, it will be appreciated that other robots and/or obstacles may prevent the second robot 350 from circumnavigating the first and third robots 360, 370 to reach its destination.

In a second stage 320 the first robot 360 elevates itself above the surface in the first location by deploying and extending its legs, thereby creating a space beneath it for the second robot 350 to fit through. In a third stage 330, the second robot 350 is moving from its original position in the second location towards the third location and is shown partially beneath the first robot 360 between its extended legs as it moves beneath the first robot 360. In the fourth stage 340 the second robot 350 has reached the third location on the opposite side of the first robot 360. FIG. 9 shows the first robot 360 elevated when the second robot reaches the third location, however in other embodiments, the first robot 360 may have lowered itself or have begun to do so when the second robot 350 reaches the third location.

In some embodiments, tunnelling methods may comprise a plurality of robots in a plurality of locations along a pathway intermediate the first and third locations elevating themselves.

In the example shown in FIG. 9 the first robot 360 elevates itself from an un-elevated arrangement in the first location without its legs extended. However, in other embodiments of tunnelling methods, the first robot may instead further elevate itself from an already elevated arrangement in the first location. For example, if the first robot is the uppermost robot of a stack of interconnected robots in the first location, the first robot may further elevate itself by further extending its legs, thereby lifting itself, as well as the other robots stacked beneath it and connected to it off of a base surface, thereby providing space for the second robot to move through a space beneath the lifted interconnected robots.

In some embodiments the tunnelling method may comprise the first and second robots communicating with each other. For example, the second robot may transmit a signal to the first robot indicating that it the first robot is obstructing its route to the third location, which may trigger the robot to elevate itself. In some embodiments, the first robot may only elevate itself if it determines that doing so is feasible, for example if it is adequately supported by a surface or one or more other robots below it.

The multi-robot system may be configured to perform embodiments of methods comprising a second robot positioned beneath an elevated first robot moving out from beneath the first robot and the first robot subsequently lowering itself, for to enable a robot stacked on top of another to move away from the stack. Such a method may be the reverse of a stacking method as described above, such as a stacking method as described with reference to FIG. 8.

FIG. 11 is a diagram of an example of a logistics network utilising one or more multi-robot systems as described above. The robots are configured to store objects within multiple storage facilities 400 and to transport them between different storage facilities 400; between the storage facilities and production facilities 410, long-distance transport vehicles 420, short-distance transport vehicles 430, or customer locations 440. The robots are also configured to load and unload themselves from said vehicles 420, 430 and to transport objects between customer locations and short-distance transport vehicles 430. In such a network, the robots do not require intermediate handling by robots or people and can independently transport objects. The movement of goods does no longer need to be executed in a mostly sequential fashion as with the existing solutions but can now be fully automated as the robots can move themselves in a parallel fashion, resulting in faster and more flexible retrieval, delivery and/or changeover when loading and/or unloading vehicles.

Robots and systems as described herein may also provide or enable net-zero means for transporting and/or storing objects and/or may reduce packaging waste. Robots as described herein may be reusable in the same manner as passive non-self-actuated containers, and various sizes of robots may differently-sized goods that would otherwise be transported inside conventional cardboard or plastic packaging thereby reducing required packaging material and waste thereof. Additionally, robots may significantly reduce congestion in ports or intermediate storage areas and may ultimately shorten the delivery time of goods.

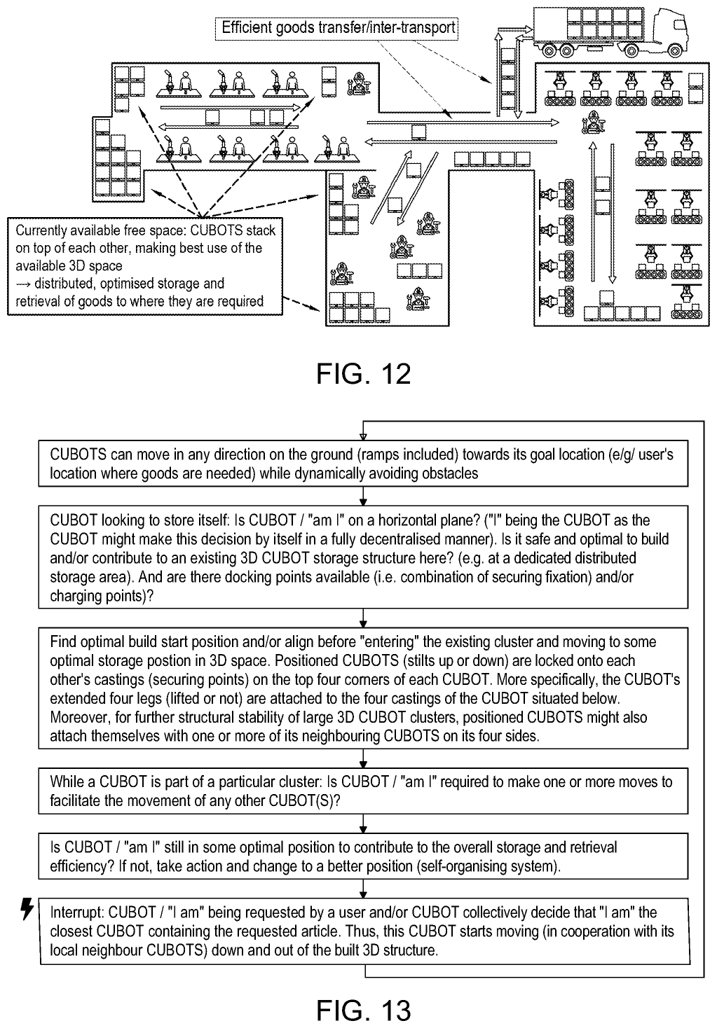

FIG. 12 is a conceptual diagram of a facility utilising a multi-robot systems as described above. The facility does not require a dedicated central warehouse or storage facility and instead stores objects in a distributed manner in currently available free spaces using the multi-robot system. The robots are referred to as ‘CUBOTS’ in the figure.

The system may intelligently store objects close to where they are required the most frequently, for example in the nearest of a plurality of available decentralised storage areas, thereby facilitating agile just-in-time manufacturing. Such decentralised storage areas may change over time as production processes are modified or an operating business grows. The robots and/or multi-robot system may detect such storage areas, and may thereby provide a flexible solution that adapts to such changes.

Additionally, robots within specific storage areas may arrange themselves such that robots containing more frequently or imminently required objects are able to reach destinations sooner. For example such robots may be arranged in the base layers of multi-robot stacks, and or adjacent the edges of groups of packed together robots (such as the edges closest to destinations). In some such embodiments, robots may rearrange themselves within the storage areas in order to maintain such a configuration in response to changes in predicted demands of robot contents. Such arrangements may be determined by the robots interacting with each other, exchanging information, and or making collective decisions, or may be determined by a central or hybrid control system. For example a robot requested more frequently than a neighbouring robot positioned beneath it may exchange positions with it, or decide to move to another lower position with some probability and/or priority. Such methods may more efficiently use available storage space and enable faster delivery of objects by the robots.

In some embodiments, the weight and/or weight distribution of individual robots and/or their contents may be known to and/or assessed, for example a robot may measure the weight of its contents and may communicate said weight to other robots and/or to one or more remote and/or central controllers. In such embodiments, robots may arrange themselves at least in part in dependence upon their weights. For example, robots with heavier contents may position themselves beneath robots with lighter contents. This may result in a more stable stack and/or cluster of robots, may decrease the energy consumed when lifting robots, and may allow additional robots to be stacked without exceeding weight or stability limits.

A system may track the locations and/or contents of all of the robots either centrally or in a distributed manner (for example, robots may inform each other of their contents and/or locations). The system may intelligently determine which of a plurality of robots containing a given object to deliver such an object in response to a request for such an object, for example based on locations of multiple robots containing such an object relative to a requested destination.

While robot systems are illustrated as being used in storage, production, and logistics situations. It will be appreciated that robots as described herein may also be used in various industries, such as retail, healthcare, construction, agriculture, disaster relief, and/or emergency support.

FIG. 13 shows an example of a navigation of a robot, referred to as a ‘CUBOT’. It will be appreciated that in other embodiments variation may be made to the flow, for example the listed steps may be performed in a different order. Furthermore, multiple users might request the same articles at the same time, if in such situations, the requested article is only stored in a single robot, the two retrieval/delivery tasks may be prioritised and/or routes optimised, and robot may deliver to both users before returning to a storage cluster.

In some embodiments, users (such as human workers or other computerised or robotic systems) can request one or more robots storing one or more particular items deliver said items to said user and/or to one or more specific locations. For example, a user may request an item using a computer, tablet, or smartphone. The robots may thereby facilitate customized single-batch production of items and/or may adapt to changing production environments.

FIGS. 14a and 14b show legs-withdrawn and legs-deployed configurations of a robot 500 with legs 530 configured to be deployed rotationally from withdrawn positions in a pair of opposite side faces of the body 510 of the robot. It will be appreciated that this alternate robot design may comprise any suitable optional features of robots 100, 105 with linearly deploying legs described above.

In FIG. 14b the legs 530 of the robot are deployed to positions on an extension of a diagonal of the footprint of the robot, offset from the corners of the body 510 of the robot 500 by rotating them 135° from their withdrawn positions. This may enable a plurality of such robots to adopt arrangements as shown in FIGS. 4a, 5, 7a and 7b. Alternatively, or additionally, the legs may be configured to be deployed to different positions by rotating the legs different amounts, for example, by rotating the legs out by 90°, an arrangement as shown in FIG. 4b may be adopted, and by rotating two legs in opposite corners out by 90° and the remaining two legs out by 45°, an arrangement as shown in FIG. 4c may be adopted.

The legs 530 of the robot 500 shown in FIGS. 14a and 14b rotate about axes close to the corners of the robot and which are arranged vertically, parallel to the length of the legs 530. It will be appreciated that in alternative embodiments, legs may be rotated from different withdrawn positions, around differently oriented axes, and or may be both rotationally and linearly deployed (for example an offset between a leg and the axes about which it rotates out of the body may be variable, such that the leg may be both rotated out of the body and displaced laterally away therefrom).

The lines running partially along the outside edges of the footprint of the top of the robot as shown in FIGS. 14A and 14B illustrate raised portions on top of the robot. Each of two parallel raised portions form a pair that are spaced apart from each other such as to both accommodate and guide a wheel of a robot driving over the top of the illustrated robot.

While certain arrangements have been described, they have been presented by way of example only, and are not intended to limit the scope of protection. The inventive concepts described herein may be implemented in a variety of other arrangements. In addition, various additions, omissions, substitutions and changes may be made to the arrangements described herein without departing from the scope of the invention as defined by the following claims.

1: A robot comprising:
a drive for moving the robot over a surface; and
a lift mechanism for elevating the robot above the surface such that another identical robot is able to move underneath the elevated robot.

2: The robot according to claim 1, wherein the lift mechanism comprises a plurality of legs configured to be laterally displaced into and out of a footprint of the remainder of the robot and to extend lengthwise.

3: The robot according to claim 2, wherein the plurality of legs are configured to be displaced out of the footprint of the remainder of the robot to positions on an extension of a diagonal of the footprint offset from corners of a body of the robot such that they do not obstruct any face of the body along an axis perpendicular to the face.

4: The robot according to claim 2, wherein the plurality of legs are configured to be displaced out of the footprint of the remainder of the robot to positions adjacent a pair of opposite faces of a body of the robot.

5: The robot according to claim 4, wherein the positions are each at an edge of the opposite faces that defines a corner of the body of the robot.

6: The robot according to claim 4,
wherein two of the legs are displaced to positions at edges of the opposite faces that define opposite corners of the body of the robot, and
wherein two of the legs are displaced to positions part-way along said opposite faces that are separated from two other corners of the body by at least a width of one of the plurality of legs.

7: The robot according to claim 2, wherein the plurality of legs are configured to be displaced into and out of the footprint of the robot linearly and/or by rotating the legs about an axis parallel to their lengths.

8: The robot according to claim 2, further comprising one or more connectors for connecting an end of at least one of the legs to an opposite end of a leg of another identical robot and/or to at least one connection point on the surface.

9: The robot according to claim 2, further comprising an electrical connector or inductive charger at at least one of a lower end of at least one of the legs, an upper end of at least one of the legs, a bottom surface of the robot, or a top surface of the robot.

10: The robot according to claim 2, further comprising an electrical connector or inductive charger on each of an upper surface and a lower surface of the robot, the electrical connector or inductive charger on the lower surface of the robot conductively connected to the electrical connector or inductive charger on the upper surface of the robot in a manner that facilitates through charging.

11: The robot according to claim 1, wherein the drive is a holonomic drive.

12: The robot according to claim 1, wherein the drive comprises a plurality of wheels configured to pivot about vertical axes.

13: The robot according to claim 1, wherein the drive is configured to move the robot across upper surfaces of one or more identical robots.

14: The robot according to claim 1, further comprising one or more temporarily deployable bridging supports for laterally extending at least part of an upper surface of the robot.

15: The robot according to claim 1, further comprising one or more sensors for determining its location and/or movement and/or for detecting objects and/or other robots in its vicinity.

16: The robot according to claim 1, wherein the robot is a container for holding objects.

17: The robot according to claim 16, wherein the robot is an enclosed container for holding objects.

18: The robot according to claim 16, wherein the robot defines a structural frame for receiving objects.

19: The robot according to claim 1, further comprising one or more stacking connectors for connecting a base of the robot to an upper surface of another identical robot, and/or for connecting an upper surface of the robot to a base of an identical robot.

20: A system comprising:
a plurality of robots according to claim 1.

21: A method of operating a multi-robot system, the method comprising:
a first robot elevating itself relative to a surface and a second such robot moving into a space beneath the first robot,
wherein the first and second robots each comprise a drive for moving itself and the first robot comprising a lift mechanism for elevating itself above a surface such that another identical robot is able to move underneath it.

22: The method according claim 21, further comprising the second robot positioning itself beneath the first robot.

23: The method according to claim 21, wherein the second robot moves from an initial location to a subsequent location on an opposite side of the first robot via the space beneath the first robot.

24: The method according to claim 21, wherein the first robot elevates itself relative to the surface in response to a received signal.

25: The method according to claim 24, wherein after receiving the signal, the first robot evaluates whether elevating itself relative to the surface is feasible and elevates itself relative to the surface upon determining that doing so is feasible.

26: The method according to claim 24, wherein the first robot receives the signal from the second robot or from a control system.

27: A non-transitory storage media comprising computer instructions executable by a processor of a robot that comprises a drive for moving itself and a lift mechanism for elevating itself above a surface such that another identical robot is able to move underneath, the computer instructions when executed by the processor causing the robot to elevate itself above a surface.
